(19) United States
(12) Patent Application Publication
(10) Pub. No.: US 2026/0163673 A1
(43) Pub. Date: Jun. 11, 2026

(54) INTERFACE WITH INCREASED ERROR CORRECTION CAPABILITY

(71) Applicant: MARVELL ASIA PTE LTD, Singapore (SG)

(72) Inventors: Gregory Kovishaner, Petah-Tikva (IL); Ronen Goldberg, Givat Shmuel (IL)

(21) Appl. No.: 19/271,246

(22) Filed: Jul. 16, 2025

Related U.S. Application Data
(60) Provisional application No. 63/673,368, filed on Jul. 19, 2024.

(51) Int. Cl. H04L 1/00

(52) U.S. Cl. CPC H04L 1/0042; H04L 1/0045

(57) ABSTRACT

An interface reduces the impact of power fluctuations on data transmissions includes F forward error correction (FEC) encoders. A transmit (Tx) FEC mapping module is configured to receive Q bits corresponding to an info-message on a parallel input bus and map the Q bits to D data portions each corresponding to one of the F FEC encoders, S slices, and B time slots for time division multiplexing (TDM). Each of the F FEC encoders is configured to generate P/F FEC parity bits for D/F data portions. The interface includes S Tx parallel registers corresponding to the S slices, respectively and S sets of L lanes. Each of the S Tx parallel registers is connected to one of the S sets of L lanes and is configured to transmit D/S data portions and P/S FEC parity bits over a communications channel using TDM and the B time slots.

### CROSS-REFERENCE TO RELATED APPLICATIONS

This application claims the benefit of U.S. Provisional Application No. 63/673,368, filed on Jul. 19, 2024. The entire disclosure of the application referenced above is incorporated herein by reference in its entirety.

### FIELD

The present disclosure relates to interfaces, and more particularly to die-to-die interfaces for data transfer between dies within a package.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Interfaces such as Die-to-Die (D2D) interfaces provide data transfer between chips or chiplets of a package. Some ICs include a parallel data bus with a large number of parallel lanes. Connecting all of the parallel lanes from one die to another within the single package may be impractical. Steps need to be taken to handle errors such as power glitches that may occur during transmission.

### SUMMARY

An interface configured to reduce the impact of power fluctuations on data transmissions, the interface includes F forward error correction (FEC) encoders, where F is an integer greater than one. A transmit (Tx) FEC mapping module is configured to receive Q bits corresponding to an info-message on a parallel input bus; and map the Q bits to D data portions each corresponding to one of the F FEC encoders, S slices, and B time slots for time division multiplexing (TDM), where Q, D, S, and B are integers greater than one. Each of the F FEC encoders is configured to generate P/F FEC parity bits for D/F data portions, where P is an integer greater than one. The interface includes S Tx parallel registers corresponding to the S slices, respectively and S sets of L lanes. Each of the S Tx parallel registers is connected to one of the S sets of L lanes and is configured to transmit D/S data portions and P/S FEC parity bits over a communications channel using TDM and the B time slots.

In other features, the transmit (Tx) FEC mapping module is configured to map D/F of the D data portions to each of the F FEC encoders. The transmit (Tx) FEC mapping module is configured to map adjacent ones of the D data portions in the Q bits of the info-message to different ones of the F FEC encoders. First ones of the D data portions have a first bit length, and second ones of the D data portions have a second bit length different than the first bit length. The transmit (Tx) FEC mapping module is configured to balance mapping of the first ones of the D data portions and the second ones of the D data portions to each of the F FEC encoders.

In other features, a sum of Q and P is equal to L times S times B. D is equal to a product of F, S, and B. S receive (Rx) parallel registers each configured to receive D/S received data portions and P/S received parity bits on a corresponding one of the S sets of L lanes during the B time slots.

In other features, the interface includes F FEC decoders and a receive (Rx) FEC mapping module configured to map the D received data portions and the P received parity bits to corresponding ones of the F FEC decoders. Each of the F FEC decoders is configured to selectively identify and correct errors in corresponding ones of the D received data portions using corresponding ones of the P received parity bits.

In other features, a Rx FEC remapping module configured to remap the D received data portions into Q received bits corresponding to a received info-message.

In other features, each of the L lanes includes a B:1 serializer/deserializer connected to one of the S Tx parallel registers, a first ball connected to the B:1 serializer/deserializer, a second ball connected to one of the S Rx parallel registers, and a wire connected to the first ball and the second ball. The interface is configured to identify and correct a power glitch affecting the L lanes corresponding to one of the S slices during one of the B time slots.

In other features, Q=1728, S=2, F=4, and L=58. P=D.

A package configured to reduce the impact of power fluctuations on data transmissions between package components, the package includes an interposer including a plurality of wires, a first input/output (I/O) chiplet connected by a first plurality of balls to the plurality of wires of the interposer, a core chiplet connected by a second plurality of balls to the plurality of wires of interposer, and first and second ones of the interface connecting the first I/O chiplet to the core chiplet.

In other features, a second I/O chiplet connected by a third plurality of balls to the plurality of wires of the interposer, and third and fourth ones of the interface connecting the second I/O chiplet to the core chiplet.

An interface configured to reduce the impact of power fluctuations on data transmissions includes S receive (Rx) parallel registers each configured to receive D/S received data portions and P/S received parity bits on a corresponding one of S sets of L lanes during B time slots, wherein S is equal to a number of slices, D is equal to a number of data portions, P is equal to a number of parity bits, and wherein S, D, P and L are integers greater than one. The interface includes F FEC decoders, where F is an integer greater than one. A receive (Rx) FEC mapping module is configured to map D received data portions and P received parity bits to corresponding ones of the F FEC decoders. Each of the F FEC decoders is configured to selectively identify and correct errors in corresponding ones of the D received data portions using corresponding ones of the P received parity bits.

In other features, a Rx FEC remapping module is configured to remap the D received data portions into Q received bits corresponding to a received info-message. First ones of the D data portions have a first bit length, and second ones of the D data portions have a second bit length different than the first bit length. Q=1728, S=2, F=4, and L=58, and P=D.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF DRAWINGS

FIG. 1 is a functional block diagram of an example of forward error correction (FEC) used in a communication channel;

FIG. 2 is a functional block diagram of an example of two parallel forward error correction (FEC) units used in the same communication channel;

FIG. 3 is a functional block diagram of an example of D2D communication channel based on a package including input/output chips or chiplets and a core chip or chiplet arranged above an interposer and a substrate according to the present disclosure;

FIG. 4 is a functional block diagram and schematic of an example of a lane between transmit and receive parallel registers according to the present disclosure;

FIG. 5 is a functional block diagram and schematic of an example of a slice including L lanes between transmit and receive parallel registers according to the present disclosure;

FIG. 6 is a functional block diagram of an example of die-to-die interface;

FIG. 7 is a functional block diagram and schematic of an example of a slice including L lanes between transmit and receive parallel registers according to the present disclosure;

FIG. 8 is an example of field and bit mapping of a transmit message after FEC is generated and including an info-message with Q bits and P FEC parity bits according to the present disclosure;

FIG. 9 is a functional block diagram of an example of mapping and remapping systems according to the present disclosure;

FIG. 10 illustrates an example of mapping of the S slices to the F transmit FEC encoders, the communications channel and de-mapping and decoding at F receive FEC decoders according to the present disclosure;

FIG. 11 is an example of a time division multiplexing (TDM) frame according to the present disclosure;

FIG. 12 is an example of transmit mapping of the info-message to D data portions according to the present disclosure;

FIG. 13 is an example of receive mapping of the info-message to D data portions and D FEC parity bits according to the present disclosure;

FIG. 14A is a functional block diagram of an example of transmit FEC input mapping to the F transmit FEC encoders according to the present disclosure;

FIG. 14B is a functional block diagram of an example of the F transmit FEC encoders according to the present disclosure;

FIG. 15A is a functional block diagram of an example of receive FEC output remapping to the F receive FEC decoders according to the present disclosure;

FIG. 15B is a functional block diagram of an example of the F receive FEC decoders according to the present disclosure; and

FIG. 16 is a flowchart of a method for providing an interface such as a die-to-die interface for a package according to the present disclosure.

In the drawings, reference numbers may be reused to identify similar and/or identical elements.

### DESCRIPTION

Forward Error Correction (FEC) is a digital signal processing technique that enhances data reliability by introducing redundant data (e.g., error-correcting-code or code-word-check or FEC-parity) before data transmission. The FEC ensures data integrity over potentially unreliable or noisy communication channels. In general, the communications channel has unknown error characteristics. Errors may include arbitrary single errors, groups of errors (bursts), or a mixture of both types of errors.

The FEC parity is added to the transmitted data (e.g., an info-message). At the other end of the communications channel, a receiver receives the info-message and the FEC parity bits, which may have been corrupted during transmission. The received FEC parity bits are used to identify and correct errors in the info-message that is received.

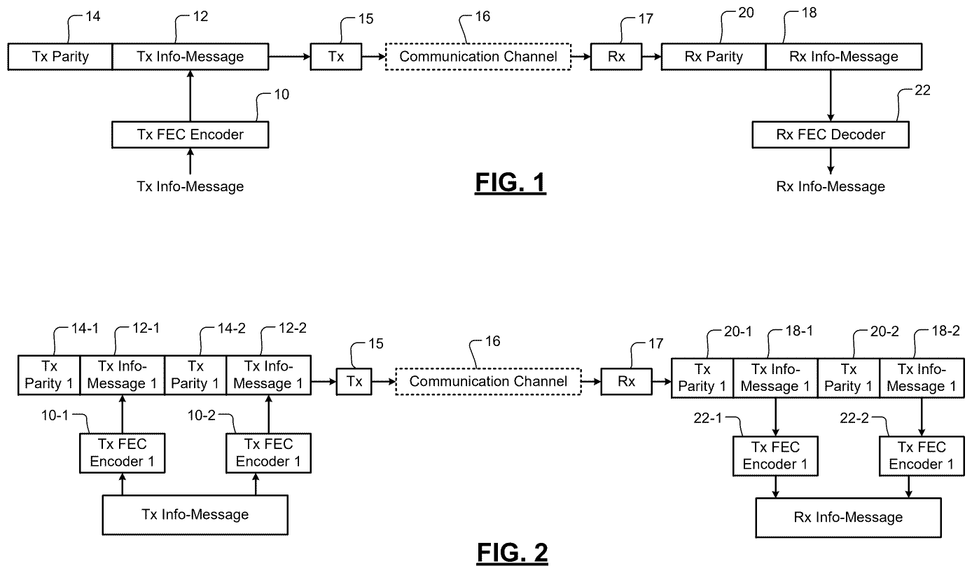

Referring now to FIG. 1, a transmit (Tx) info-message is input to a Tx forward error correction (FEC) encoder 10, which outputs a Tx info-message 12 and FEC Tx parity bits 14 to a transmitter 15. The transmitter (Tx) 15 outputs the Tx info-message 12 and the FEC Tx parity bits 14 on a communications channel 16. A receiver (Rx) 17 receives a Rx info-message 18 and Rx FEC parity 20. A Rx FEC decoder 22 uses the Rx FEC parity 20 to correct errors in the Rx info-message 18 and remove the Rx FEC parity 20.

Referring now to FIG. 2, parallel FEC engines can be used. The info-message can be divided into equal lengths and output to two or more parallel FEC engines. For example, the Tx info-message is split and input to Tx FEC encoders 10-1 and 10-2, which output Tx info-messages 12-1 and 12-2 and FEC Tx parity bits 14-1 and 14-2 to a transmitter 15. The transmitter (Tx) 15 outputs the Tx info-message 12-1 and 12-2 and the Tx parity 14-1 and 14-2 to the communications channel 16. The receiver (Rx) 17 receives Rx info-messages 18-1 and 18-2 and Rx FEC parity 20-1 and 20-2. Rx FEC decoders 22-1 and 22-2 use the Rx FEC parity 20-1 and 20-2 to correct errors in the Rx info-messages 18-1 and 18-2 and remove the Rx FEC parity 20-1 and 20-2.

This approach improves FEC gain but increases gate-count. Each of the FEC engines adds overhead (parity bits), which reduces an effective bandwidth of the communication channel 16. The parallel FEC engines are applied without any relation to a specific error pattern on the communication channel 16.

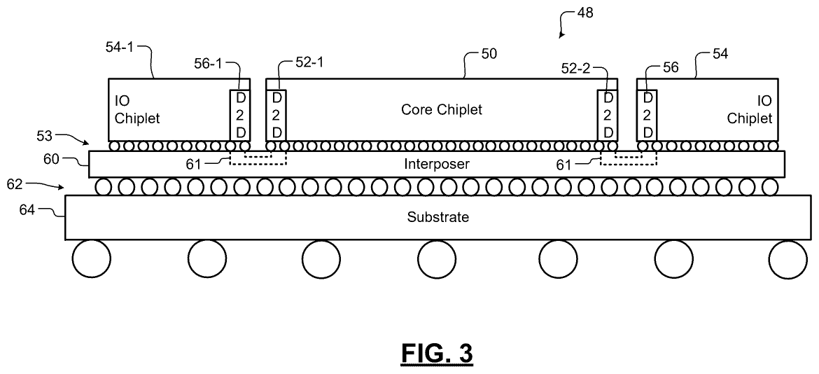

FIG. 3 shows as example of a package including Die-to-Die (D2D) interfaces. D2D interfaces support data transfer between integrated circuit dies within a single package 48. For example, a first input/output (IO) chip or chiplet 54-1 is connected by a D2D interface 56-1, balls 53, and wires 61 in an interposer 60 to a first D2D interface 52-1 of a core chip or chiplet 50. The interposer 60 includes a wire interconnect that acts as a special physical layer used to provide D2D connectivity. The core chip or chiplet 50 further includes a second D2D interface 52-2 that is connected by balls 53 and the wires 61 of the interposer 60 to a D2D interface 56 of a second IO ship or chiplet 54-2. As will be discussed further below, the D2D communication channel is implemented using multiple slices each multiple lanes and time division multiplexing (TDM) time slots. Usually, the interposer 60 is connected by balls 62 to a substrate 64.

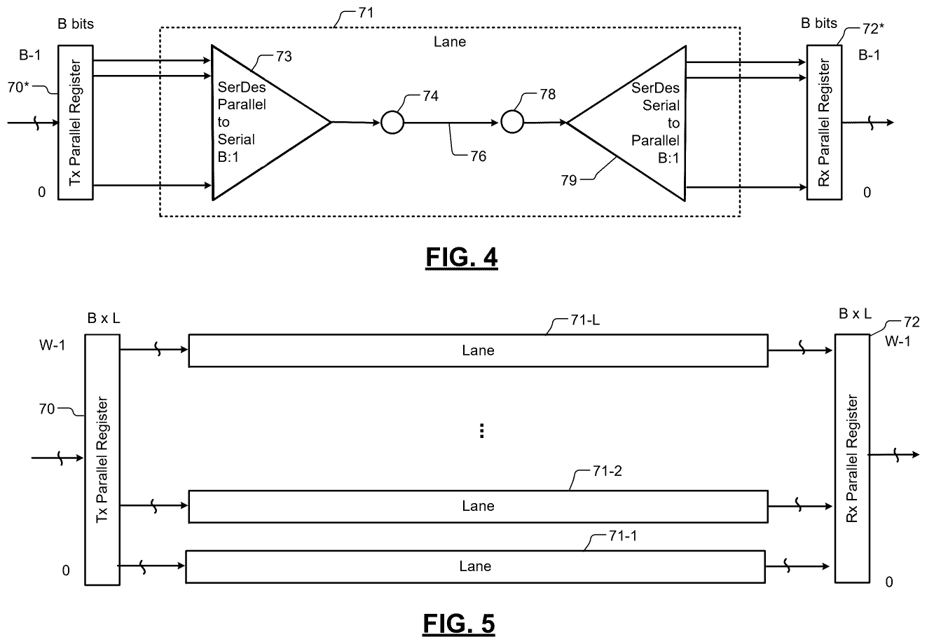

Referring now to FIGS. 4 and 5, a single lane and L lanes are shown, respectively, between Tx and Rx parallel registers. In FIG. 4, a lane 71 connects a portion of a Tx parallel register 70* to a portion of a Rx parallel register 72*. An output of a B:1 serializer/deserializer 73 is connected by a ball 74, a wire 76, and a ball 78 (e.g., a physical layer of the communications channel) to a serializer/deserializer 79 connected to Rx parallel register 72*. The lanes are unidirectional, and for each direction of data transmission dedicated lanes are provided.

In FIG. 5, L lanes 71-1, 71-2, . . . , and 71-L connect the Tx parallel register 70 to the Rx parallel register. For example, a Q-bit input word and P FEC parity bits are divided into S slices each with L lanes over B time slots, where Q, P, S, L, and B are integers. For example, Q=1728, P=128, S=2, L=58, and B=16, although other values can be used. When using the D2D interface, there may be random errors or group errors (burst) related to cross-talk noise and/or power glitches. The power glitches are serious adversely impact reliability of the D2D communication channel.

As described above, FEC is applied to improve a signal-to-noise ratio (SNR) of communication channel. In D2D, Reed-Solomon (RS) FEC code is typically used to maintain an appropriate bit-error-rate (BER) during the D2D data transfer. In other applications, other types of FEC may be used such as KP-FEC and KR-FEC. RS-FEC is the simplest FEC with less gain (can correct e.g., 16 bits of 1000), less latency (e.g., 2 clocks) and less gate-count/power. KR-FEC has greater gain (can correct e.g., 70 bits of 1000), greater latency (e.g., 7 clocks) and greater gate-count/power. KP-FEC has the greatest gain (can correct e.g., 150 bits of 1000), greatest latency (e.g., 15 clocks), and greatest gate-count/power. For D2D applications, the latency is an important parameter, for other applications—latency is less important. In this application, several FEC engines are used in parallel for D2D to increase gain without impacting latency (but reducing effective bandwidth).

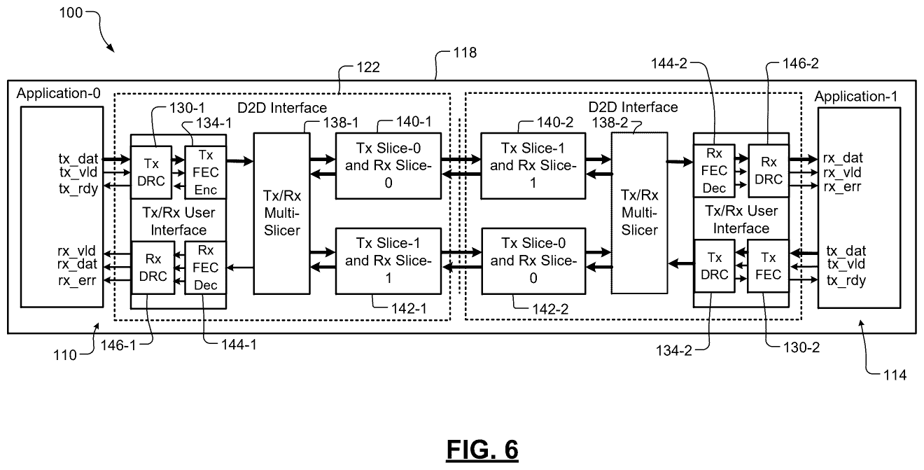

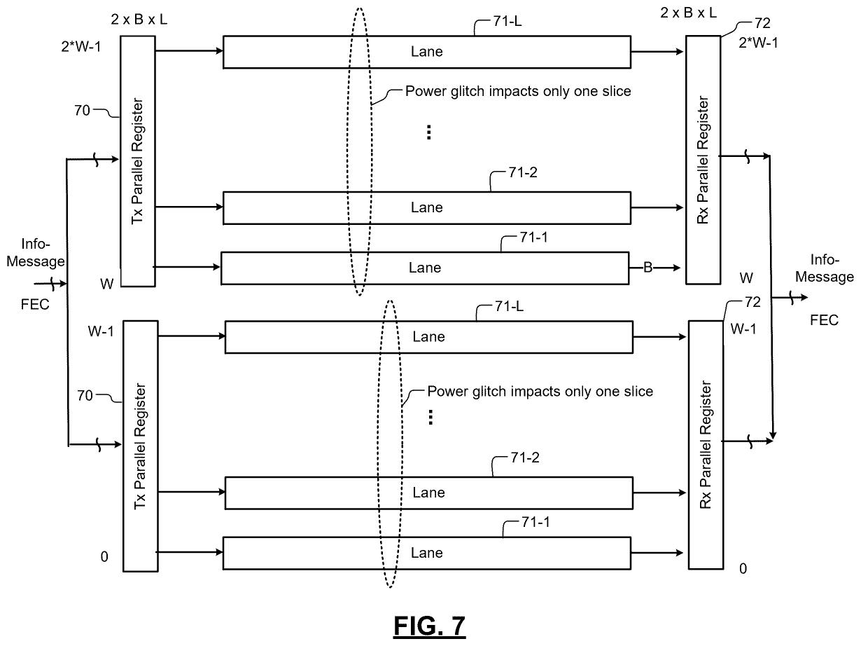

FIG. 6 shows an example of a package 100 including a first die 110 and a second die 114 that are connected by die-to-die (D2D) interfaces 122. The first die 110 includes an application (e.g., application-0) that generates data at a first data rate. The first die 110 includes transmit output data, and output/input control signals: output data is labelled (tx-dat), output control is labeled (tx_vld), and input control is labeled (tx_rdy).

A transmit data rate converter (Tx DRC) 130 (or Tx gear box) converts the first data rate and first format of data output by the application-0 to a second data rate and second format for transport through the S slices of the D2D interface 122 (two are shown). An output of the transmit data rate converter 130-1 is input to a Tx FEC encoder 134-1 that is configured to generate FEC bits for the info-messages append the FEC bits to the info-messages.

An output of the Tx FEC encoder 134 is input to a Tx/Rx multi-slicer 138-1. The Tx/Rx multi-slicer 138 splits the transmit data into the S slices (slice #0 at 140-1 and slice #1 at 142-1). Each of the slices transmits Q/S bits on L lanes with B time slots using time division multiplexing (TDM). Upon receiving the transmit slices #0 and #1, the Tx/Rx multi-slicer 138-2 recombines the S slices into receive data. A Rx FEC decoder 144-2 checks for errors and corrects the errors if needed. A receive data rate converter 146-2 (or Rx gear box) converts the second rate and second format to the first rate and the first format. The receive data rate converter 146-2 outputs receive data (rx_dat) corresponding to the received info-message, receive valid (rx_vld), and receive error (rx_err) signals to application #1. The slice is unidirectional. The multi-slicer splits/merges Tx and Rx data between two slices, e.g., Tx data is split between Tx-Slice-0 and Tx-Slice-1.

A transit path from the second die 114 to the first die 110 operates in a similar manner and sends transmit data to a Tx FEC 130-2, a Tx RDC 134-2, and the Tx/Rx multi-slicer 138-2 that slices the transmit data into the two or more slices. The two or more slices are received by the Tx/Rx multi-slicer 138-1 that merges the slices. A Rx FEC decoder 144-1 performs RS FEC decoding and error correction to restore the original info-message. A Rx DRC 146-1 converts the second data rate to the first data rate for application-0.

In some examples, Application-0 and Application-1 send info-messages to each other. Info-messages passing through D2D include Q bits (e.g., 1728 bits) (corresponding to a RS-FEC block=1728/8=216 B). The info-messages can be sent back-to-back or with a pause. In some examples, each of the S slices supports Q/S bits (1856/s=928 b). When S=2, both of the S slices (Tx/Rx Slice-0 and Tx/Rx Slice-1) are required to transfer the full info-message (928 b×2=1856 b). 128 free bits (1856-1728) are left for FEC-parity. In some examples, four parallel FEC engines are used (128 b/4=32 b per FEC engine). The Tx FEC encoder takes the input info-message (1728 b) and produces 128 check-bits (FEC-parity), and thus, 1728 b+128 b=1856 b are conveyed over D2D interface (1856/8=232 B).

The Tx/Rx multi-slicers 138-1, 138-2 perform Tx-split and Rx-merge operations, respectively (or vice versa). When transmitting, the Tx/Rx multi-slicers 138-1, 138-2 distribute the 1856 bits evenly between the S slices and FEC encoders/decoders. During reception, the Tx/Rx multi-slicer 138-1, 138-2 aligns (in time) and concatenates two 928-bit portions into the 1856-bit info-message.

In some examples, the Tx/Rx slice-0 or slice-1 (140 -1 and 142-1) represents a block including soft-IP and hard-IP. The Tx/Rx slice-0 or slice-1 (140-1 and 142-1) are utilized on both sides of the D2D interface. In some examples, the Tx/Rx slice-0 or slice-1 (140-2 and 142-2) in the opposite die is rotated (180 degrees) to ensure the latency in all of the lanes is nearly equal (using approximately the same length of wire). In some examples, high BW is used over each of the lanes (e.g., 17.2 Gbps).

Each Tx/Rx slice translates to 1/S (e.g., ½) of the info-message through the D2D interface using the L lanes (e.g., L=58). FIG. 7 shows two slices carrying the full info-message over D2D communication channel. Rx-FEC detects and corrects the info-message errors that may occur during the D2D transfer. The FEC is performed on the received Q info-message and P parity bits (e.g., 1856 b (232 B)), which includes the info-message and the check-bits received by the Rx FEC decoder 144-2. The Rx FEC decoder 144-2 locates and corrects errors, removes the check-bits, and passes the info-message without the FEC to the Rx data rate converter 146-2 (e.g., 1728 bits (216 B) after correction if any). The Rx data rate converter 146-2 converts internal D2D-PIPE's data-rate and format of the info-message (1728 bits) for Application-1. A power glitch may impact any slice and, when one of the slices is impacted, all lanes of a given slice may be impacted.

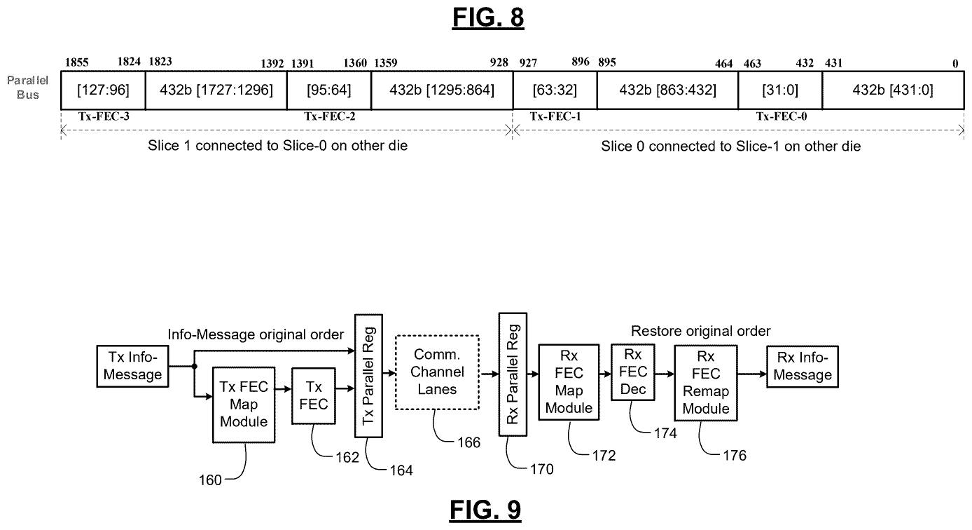

FIG. 8 shows an example of field and bit mapping of a two-slice parallel register for D2D transfer. The parallel register includes the info-message (Q data bits (e.g., 1728 b) arranged as F groups (e.g., F=4 each with 232 b) and F FEC-parity fields (e.g., F=4, each with 32 b) produced by F Tx-FEC engines (e.g., F=4 labelled 0 to 3). In some examples, P bits of the FEC-parity are evenly distributed between the S slices and between D data portions, where D is an integer greater than one. In some examples, D=P.

FIG. 9 shows map and remap functions for the D2D interface. The Tx info-message is input to a Tx FEC input map module 160. In some examples, the Tx info-message is also directly input to a Tx parallel register 164. The Tx FEC input map module 160 is configured to remap the info message into data portions and output the remapped data (or data portions) to corresponding ones of the F Tx FEC engines 162. The F Tx FEC engines 162 output the data portions and FEC bits to the Tx parallel register 164.

An output of the Tx parallel register 164 is transmitted over the communication channel to a Rx parallel register 170. The Rx parallel register 170 outputs received data portions and FEC bits to Rx FEC map module 172, which maps the data portions to corresponding ones of the Rx FEC decoders 174. The Rx FEC decoders 174 identify errors (if any), perform corrections, and output the data portions to Rx FEC remapping module 176, which remaps the data portions to a received info-message. In general, Rx FEC map module 172 can be located on either the Rx side or Tx side, but in this example only Rx-side is considered.

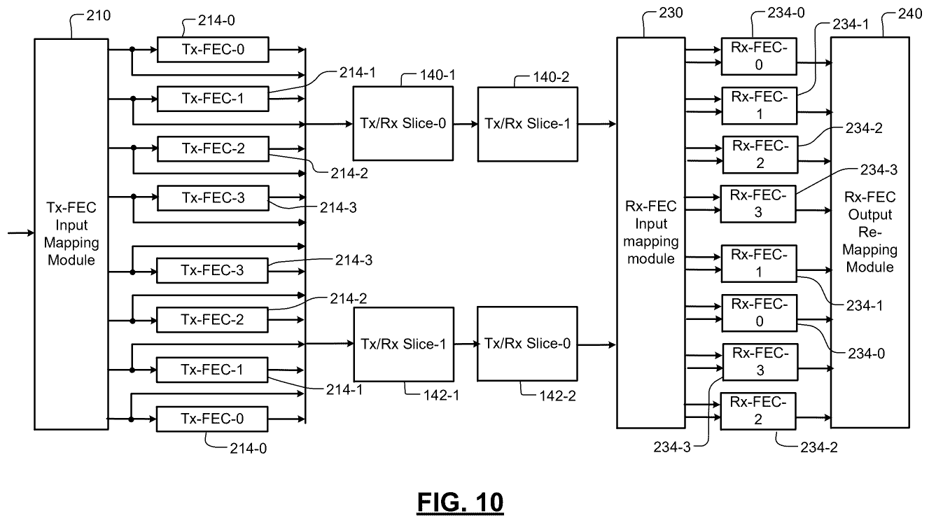

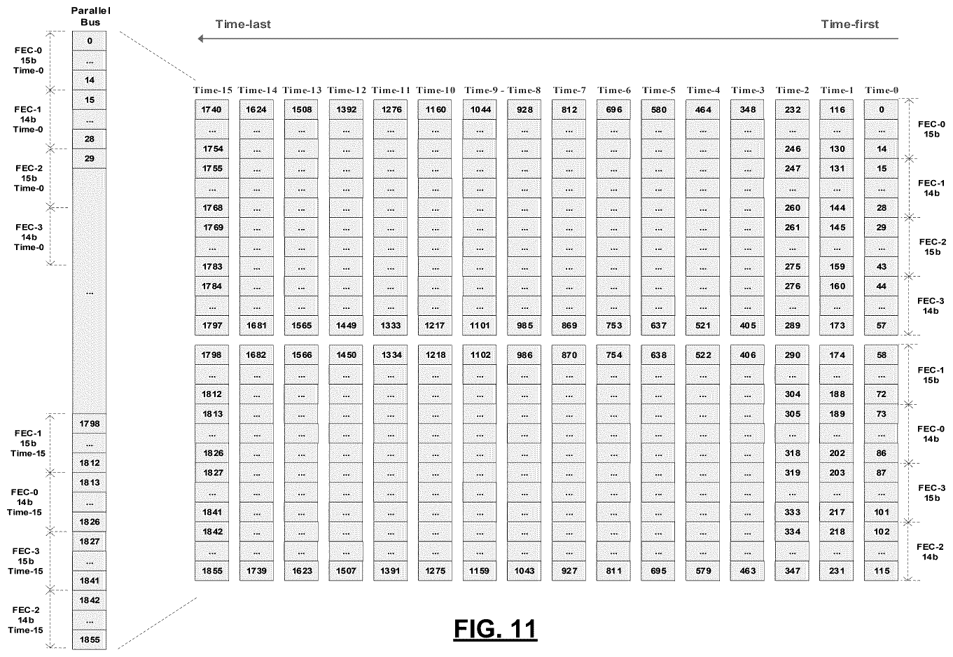

In FIG. 10, rather than using a single Tx FEC encoder as in FIG. 6, the D2D interface according to the present disclosure uses F RS FEC encoders for the S slices. A transmit path of the D2D interface from one die to another is shown. The transmit path includes a Tx FEC input mapping module 210 and F Tx FEC encoders (e.g., 214-0, 214-1, 214-2, and 214-3). A Tx FEC input mapping module 210 maps the data portions to S slices and the F Tx FEC encoders. More particularly, data portions assigned to a first slice (slice #0) are encoded by the F Tx FEC encoders (e.g., 214-0, 214-1, 214-2, and 214-3). Data portions assigned to a second slice (slice #1) are encoded by the F Tx FEC encoders (e.g., 214-0, 214-1, 214-2, and 214-3). Outputs of the Tx FEC encoders are output to slices 140-1 and 140-2 and 142-1 and 142-2.

A Rx FEC input mapping module 230 receives and maps the data portions and FEC parity of the slices to Rx FEC decoders 234-0, 234-1, 234-2, and 234-3, which perform decoding and error correction. The data portions output by the Rx FEC decoders 234-0, 234-1, 234-2, and 234-3 are input to a Rx FEC output remapping module 240, which remaps the data portions to a received info-message.

Unlike the architecture in FIG. 6, a power glitch impacts only single slice at a time in the D2D interface shown in FIG. 10 (the glitch impact is shown in FIG. 7). This error correction strategy uses multiple FEC-engines in parallel per slice. In some examples, the FEC-engines in each slice may be operated without full encoder/decoder utilization (in contrast to a single FEC-engine in FIG. 6).

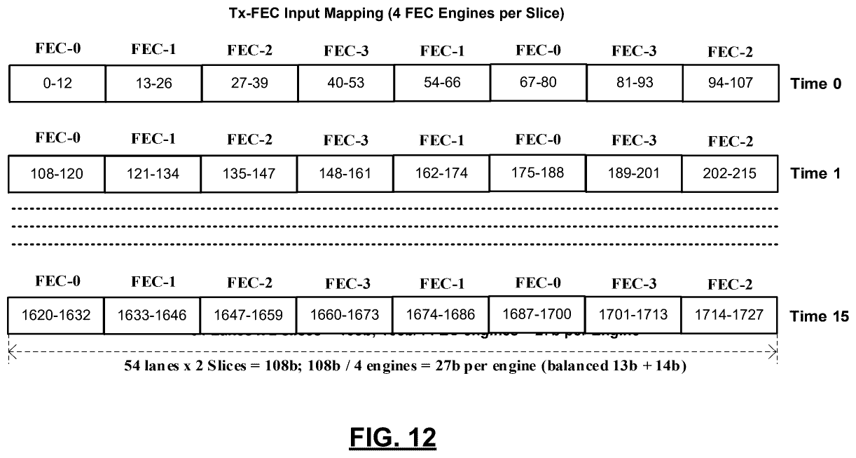

FIG. 11 shows an example of a time division multiplexing (TDM) frame representing bits of the parallel register passing through serializer/deserializers during B (e.g., 16) time-slots (e.g., from Time-0 to Time-15). Each time-slot transports in parallel 116 bits (over 2 slices corresponding to 58×2=116 lanes) in parallel using TDM. As can be appreciated, other mapping approaches can be used.

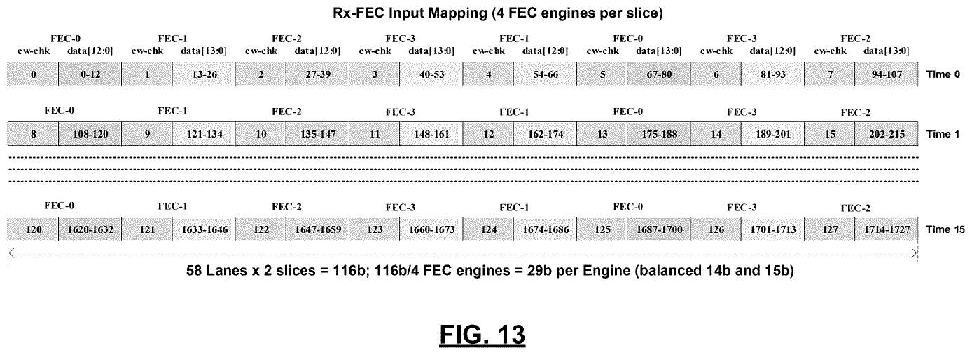

FIGS. 12 and 13 show transmit and receive mapping. FIG. 12 shows Tx FEC input mapping using 4 FEC engines per slice. There are L lanes (e.g., L=54 or 54 b) across S slices (e.g., S=2) for a total of S*L bits or 108 b. 108 b/4 FEC engines equal 27 b per FEC encoder. The FEC encoders are balanced at 13 b and 14 b. The 108 b of info-message is divided into D data portions. P=D FEC parity bits are added.

FIG. 13 shows Rx FEC input mapping. There are 58 lanes (e.g., 58 b) across 2 slices for a total of 116 b. 116 b/4 FEC engines equal 29 b per engine. The FEC engines are balanced at 14 b and 15 b.

Time per row of table shown in FIGS. 12 and 13 reflects TDM multiplexing (16 time-slots for each lane). The tables indicate data portion balancing for two slices over four FEC engines representing Tx-FEC input Map and Rx-FEC input Map functions. The Rx-FEC output re-map ping is similar to Tx-FEC input mapping. The worst-case error (power glitch) can impact all bits in a slice at a given time N (N=0 to 15), so those bits should pass through different FEC engines.

In some examples, 4 FEC decoders×2 Slices×16 time slots=128 groups. Tx-FEC input mapping includes 1728 input bits: 1728/128 groups=27 data bits per group (e.g., 13 b or 14 b data portions). In some examples, the data portions from each slice that are assigned to the same FEC at the same time N are balanced (e.g., 13 b+14 b=27 b).

Rx-FEC input mapping with 1856 input bits corresponding to 1856/128 groups=14 b or 15 b per group. A similar approach is used and two groups of the same FEC at the same time-N are always balanced: 14+15=29 b. The Rx-FEC engine corrects concurrently up to 2 symbols (16 bits). With 4 engines per slice, 100% of errors in a single slice can be corrected at a time (58 b per slice<16 b×4 engines=64 fixed bits).

Map/Re-Map functions of the Tx and Rx mapping modules can be varied using parameters such as number of application bits P, number of slices S, number of lanes L per slice S, serializer/deserializer multiplexing type (B time slots (1-to-8, 1-to-16, 1-to-32 defining the TDM-Frame)), number F of FEC engines, and number of bits per FEC-engine.

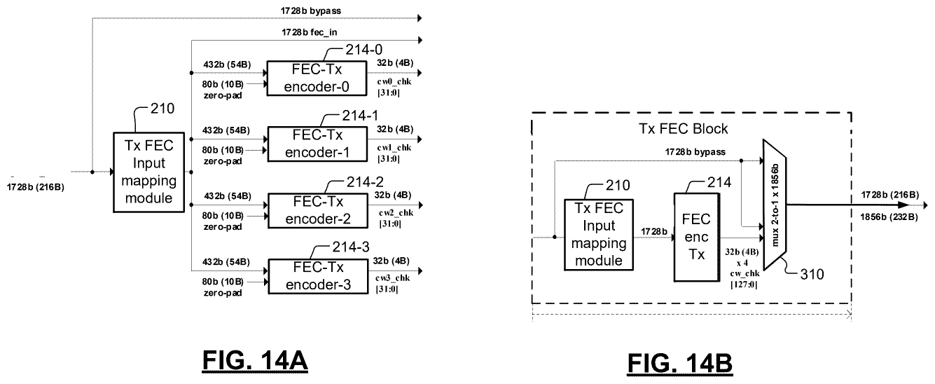

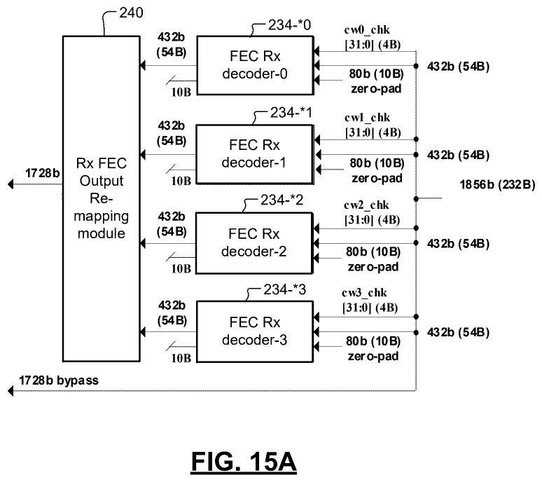

In FIG. 14A, a more detailed view of the Tx FEC input mapping module 210 and Tx FEC encoders 214-0, 214-1, 214-2, and 214-3 are shown. The input data is split amongst the Tx FEC encoders 214-0, 214-1, 214-2, and 214-3 and zero padding is performed as needed. The Tx FEC encoders 214-0, 214-1, 214-2, and 214-3 output FEC bits.

In FIG. 14B, the Tx FEC encoder 214 is shown. The input data is received and output to first and second inputs of a multiplexer 310. The input data is also input to a Tx FEC input mapping module 210 that maps the input data to the Tx FEC encoders 214 (e.g., 214-0, 214-1, 214-2, and 214-3). The Tx FEC encoders 214 output FEC bits that are input to a second input of the multiplexer 310 (e.g., the FEC bits are combined with the input data). The multiplexer 310 receives a control signal to select the first input or the second input. When the first input is selected, the input data is output. When the second input is selected, the input data and the FEC bits are output.

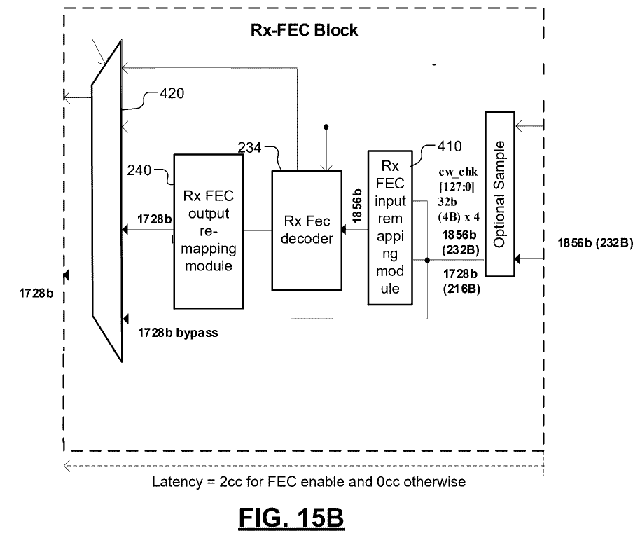

In FIG. 15A, a more detailed view of the Rx FEC decoders 234-0, 234-1, 234-2, and 234-3 is shown. The transmitted data and/or FEC bits are split amongst the Rx FEC encoders 234-0, 234-1, 234-2, and 234-3. Zero padding is performed as needed. The Rx FEC encoders 234-0, 234-1, 234-2, and 234-3 perform error detection and correction and output the corrected input data to a Rx FEC output remapping module 240. A bypass path is provided around the FEC encoders 234-0, 234-1, 234-2, and 234-3.

In FIG. 15B, the transmit data and FEC bits are input to a Rx FEC input re-mapping module 410 and to a first input of a multiplexer 420. The output of the Rx FEC input re-mapping module 410 is input to the Rx FEC decoder 234, which performs error detection and correction. The corrected data is output by the Rx FEC decoder 234 to the Rx FEC output remapping module 240. The output of the Rx FEC output remapping module 240 is input to a second input of the multiplexer 420. The multiplexer 420 selects the first input to bypass FEC and the second input when FEC is used.

The D2D interface described herein improves FEC gain over D2D data transfer using multiple FEC-engines and special data distribution functions suitable for a communication channel having the slice-based structure. The method includes selection of a proper number of RS-FEC engines and definition of width for sub-fields (data-portions) passing through the engine, development of the generic (parametric) functions for the data distribution among the FEC-engines and slices, and balancing between slices the data-portions (sub-fields of info-message and FEC-parity) passing through FEC-engines at a time of TDM-frame.

Using this method, the D2D interface can provide complete correction of errors for most adverse error scenarios when a power glitch affects the entire single slice. The D2D interface with multiple FEC engines (unlike a single solid engine) has appropriate latency over D2D while maintaining acceptable gate-count and power dissipation.

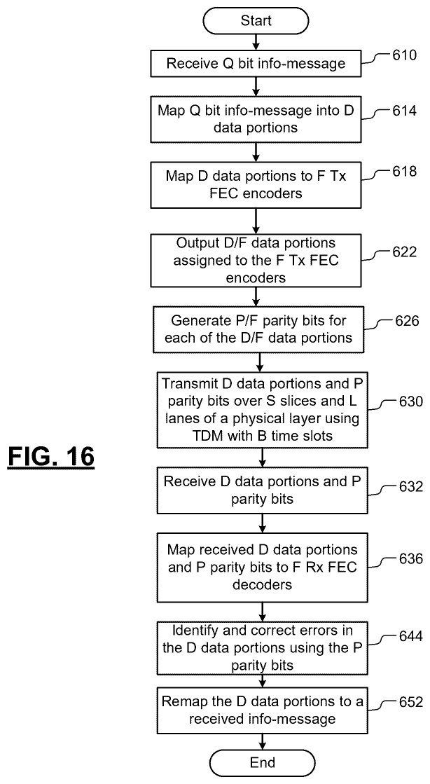

In FIG. 16, a method for providing an interface such as a die-to-die interface for a package is shown. At 610, a Q-bit info-message is received. At 614, the Q-bit info-message is mapped into D data portions. The D data portions are mapped to F Tx FEC encoders at 618. At 622, D/F data portions are output to each of the F Tx FEC encoders. At 626, each of the F Tx FEC encoders generates P/F parity bits. At 630, the D data portions, and the P parity bits are transmitted over a physical layer including S slices each with L lanes using TDM with B time slots.

At 632, D data portions and P parity bits are received. The received D data portions and P parity bits are mapped to F Rx FEC encoders at 636. At 644, the F Rx FEC encoders identify and correct errors if needed. At 652, the D data portions are remapped into a received info-message.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML 5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An interface configured to reduce the impact of power fluctuations on data transmissions, the interface comprising:
F forward error correction (FEC) encoders, where F is an integer greater than one;
a transmit (Tx) FEC mapping module configured to:
receive Q bits corresponding to an info-message on a parallel input bus; and
map the Q bits to D data portions each corresponding to one of the F FEC encoders, S slices, and B time slots for time division multiplexing (TDM), where Q, D, S, and B are integers greater than one;
wherein each of the F FEC encoders is configured to generate P/F FEC parity bits for D/F data portions, where P is an integer greater than one;
S Tx parallel registers corresponding to the S slices, respectively; and
S sets of L lanes,
wherein each of the S Tx parallel registers is connected to one of the S sets of L lanes and is configured to transmit D/S data portions and P/S FEC parity bits over a communications channel using TDM and the B time slots.

2. The interface of claim 1, wherein the transmit (Tx) FEC mapping module is configured to map D/F of the D data portions to each of the F FEC encoders.

3. The interface of claim 1, wherein the transmit (Tx) FEC mapping module is configured to map adjacent ones of the D data portions in the Q bits of the info-message to different ones of the F FEC encoders.

4. The interface of claim 1, wherein first ones of the D data portions have a first bit length, and second ones of the D data portions have a second bit length different than the first bit length.

5. The interface of claim 4, wherein the transmit (Tx) FEC mapping module is configured to balance mapping of the first ones of the D data portions and the second ones of the D data portions to each of the F FEC encoders.

6. The interface of claim 1, wherein a sum of Q and P is equal to L times S times B.

7. The interface of claim 1, wherein D is equal to a product of F, S, and B.

8. The interface of claim 1, further comprising S receive (Rx) parallel registers each configured to receive D/S received data portions and P/S received parity bits on a corresponding one of the S sets of L lanes during the B time slots.

9. The interface of claim 8, further comprising:
F FEC decoders; and
a receive (Rx) FEC mapping module configured to map the D received data portions and the P received parity bits to corresponding ones of the F FEC decoders,
wherein each of the F FEC decoders is configured to selectively identify and correct errors in corresponding ones of the D received data portions using corresponding ones of the P received parity bits.

10. The interface of claim 9, further comprising a Rx FEC remapping module configured to remap the D received data portions into Q received bits corresponding to a received info-message.

11. The interface of claim 8, wherein each of the L lanes includes:
a B: 1 serializer/deserializer connected to one of the S Tx parallel registers;
a first ball connected to the B:1 serializer/deserializer;
a second ball connected to one of the S Rx parallel registers; and
a wire connected to the first ball and the second ball.

12. The interface of claim 1, wherein the interface is configured to identify and correct a power glitch affecting the L lanes corresponding to one of the S slices during one of the B time slots.

13. The interface of claim 1, wherein Q=1728, S=2, F=4, and L=58.

14. The interface of claim 1, wherein P=D.

15. A package configured to reduce the impact of power fluctuations on data transmissions between package components, the package comprising:
an interposer including a plurality of wires;
a first input/output (I/O) chiplet connected by a first plurality of balls to the plurality of wires of the interposer;
a core chiplet connected by a second plurality of balls to the plurality of wires of interposer; and
first and second ones of the interface of claim 1 connecting the first I/O chiplet to the core chiplet.

16. The package of claim 15, further comprising:
a second I/O chiplet connected by a third plurality of balls to the plurality of wires of the interposer; and
third and fourth ones of the interface of claim 1 connecting the second I/O chiplet to the core chiplet.

17. An interface configured to reduce the impact of power fluctuations on data transmissions, the interface comprising:
S receive (Rx) parallel registers each configured to receive D/S received data portions and P/S received parity bits on a corresponding one of S sets of L lanes during B time slots, wherein S is equal to a number of slices, D is equal to a number of data portions, P is equal to a number of parity bits, and wherein S, D, P and L are integers greater than one;
F FEC decoders, where F is an integer greater than one; and
a receive (Rx) FEC mapping module configured to map D received data portions and P received parity bits to corresponding ones of the F FEC decoders,
wherein each of the F FEC decoders is configured to selectively identify and correct errors in corresponding ones of the D received data portions using corresponding ones of the P received parity bits.

18. The interface of claim 17, further comprising a Rx FEC remapping module configured to remap the D received data portions into Q received bits corresponding to a received info-message.

19. The interface of claim 17, wherein first ones of the D data portions have a first bit length, and second ones of the D data portions have a second bit length different than the first bit length.

20. The interface of claim 17, wherein:
Q=1728, S=2, F=4, and L=58, and
